(19) United States
(12) Patent Application Publication
(10) Pub. No.: US 2016/0145100 A1
(43) Pub. Date: May 26, 2016

(54) ELECTRODE STRUCTURAL BODY

(71) Applicant: NGK INSULATORS, LTD., Nagoya-Shi (JP)

(72) Inventors: Mikio MAKINO, Nagoya-City (JP); Yoshiyuki KASAI, Kasugai-City (JP); Tatsuya TERAZAWA, Kasugai-City (JP); Naoya TAKASE, Konan-City (JP); Shoji YOKOI, Nagoya-City (JP)

(21) Appl. No.: 14/948,455

(22) Filed: Nov. 23, 2015

(30) Foreign Application Priority Data
Nov. 26, 2014 (JP) 2014-238792

(51) Int. Cl. C01B 13/11

(52) U.S. Cl. CPC C01B 13/115; C01B 2201/22

(57) ABSTRACT

A first electrode structural body includes a plurality of electrode pairs. Of a plurality of electrodes forming the plurality of electrode pairs, at least one electrode forms a common electrode common to the plurality of electrode pairs.

### CROSS-REFERENCE TO RELATED APPLICATION

This application is based upon and claims the benefit of priority from Japanese Patent Application No 2014-238792 filed on Nov. 26, 2014, the contents of which are incorporated herein by reference.

### BACKGROUND OF THE INVENTION

1. Field of the Invention

The present invention relates to an electrode structural body containing an insulating body and a conductive material, which is suitable for use, e.g., in a dielectric-barrier discharge electrode, an ozone generator, or the like.

2. Description of the Related Art

Heretofore, low-temperature plasma generators described, for example, in International Publication No. WO 2008/108331 and Japanese Patent No, 3015268 have been known as a structural body containing an insulating body and a conductive material.

In a low temperature plasma generator described in International Publication No WO 2008/108331, a conducting paste is applied over at least an inner surface of a space formed within an insulating body in a hermetic manner, so that a continuous portion of the conducting paste serves as a discharge electrode. The insulating body is a pipe-like insulating body having sealed opposite ends. A pair of electrode elements have respective discharge electrodes arranged in parallel, and the electrode elements are joined together such that the pipe-like insulating bodies of the electrode elements are provided in line contact with, or closely to each other.

In a low temperature plasma generator described in Japanese Patent No. 3015268, electric rod conductive bodies are inserted in through-holes formed in rod ceramic dielectric bodies and extending in longitudinal directions thereof, and both ends of the electric conductive bodies and the dielectric bodies are integrally joined and sealed with a glass or an inorganic or organic adhesive, so as to constitute a plurality of electrodes. In particular, when the electrodes are joined together through the ceramic dielectric bodies in a line contact state, a surface treatment agent containing material selected from the group consisting of a metallic element, a rare-earth element, an inorganic salt, and an organic metallic compound including one of such elements is applied on surfaces of the electric rod conductive bodies or the rod ceramic dielectric bodies, and the applied agent is subjected to a heat treatment.

### SUMMARY OF THE INVENTION

However, in the electrode described in International Publication No WO 2008/108331, the pipe-like insulating bodies of the electrodes are provided in line contact with, or closely to each other. Each pair of the electrodes generates one electric discharge. Thus, in the case of generating electric discharge, e.g., at two positions, two pair of electrodes, i.e., four electrodes, are required. Therefore, assuming that the number of positions for generating electric discharge is “n”, the required number of electrodes is “2n”. In this case, two electrodes are required for generating one electric discharge.

Further, assuming that the number of positions for generating electric discharge relative to the number of electrodes (=number of positions for generating electric discharge/number of electrodes) is the utilization efficiency of the electrodes, the utilization efficiency is constant, i.e., 0.5, regardless of the number of positions for generating electric discharge, and it is not possible to improve the utilization efficiency of the electrodes. Further, if the number of positions for generating electric discharge is increased in order to increase the ozone generation rate, the required number of the electrodes is doubled. Consequently, the product size is large, and the pressure loss is large disadvantageously.

In the low temperature plasma generator described in Japanese Patent No 3015268, the adjacent electrodes (to which potentials having different polarities are applied) are joined together in a line contact state. Therefore, it is not expected to flow fluid such as air between the adjacent electrodes.

Further, from a standpoint of the electric field distribution contributed to the ozone generation efficiency, the electric field is generated only in a recess having the electrode joint portion as a bottom thereof in the surfaces of the adjacent electrodes (surfaces of the respective rod ceramic dielectric bodies). The spread of the electric field is small in comparison with electric field generated between electrodes which face each other with a space (gap) between the electrodes. Therefore, in the example of Japanese Patent No 3015268, the efficient ozone generation cannot be expected.

The present invention has been made in consideration of such problems, and an object of the present invention is to provide an electrode structural body which makes it possible to reduce the number of electrodes relative to a given ozone generation rate and accordingly achieve reduction in the size and the pressure loss, and further to realize cost reduction.

[1] An electrode structural body according to the present invention includes a plurality of electrode pairs. Of a plurality of electrodes forming the plurality of electrode pairs, at least one electrode forms a common electrode common to the plurality of electrode pairs.
[2] In the present invention, two electrodes forming at least one electrode pair among the plurality of electrode pairs may be spaced from each other. That is, it is sufficient that two electrodes forming at least one electrode pair among the plurality of electrode pairs are spaced from each other, and two electrodes forming each of the other electrode pairs may contact each other.
[3] In this case, preferably, among the two electrodes forming the at least one electrode pair, one electrode may be the common electrode. Since the common electrode is spaced from the other electrodes, it is possible to form a plurality of positions for generating electric discharge around the common electrode, and increase the total number of positions for generating electric discharge.
[4] In the case [2] or case [3], preferably, the electrode may include a tubular insulating body and a conductor provided inside the insulating body, and the insulating bodies of the two electrodes may be spaced from each other, and a space may be present between the insulating bodies.
[5] In the present invention, the plurality of electrodes forming the plurality of electrode pairs may be spaced from each other. In contrast with the case of [2], in this case, the plurality of electrodes forming the plurality of electrode pairs are spaced from each other.
[6] In this case, preferably, the electrode may include a tubular insulating body and a conductor provided inside the insulating body, and the insulating bodies of the plurality of electrodes are completely spaced from each other, and a space is present between the insulating bodies.
[7] In the case [5] or case [6], an angle formed between a line connecting electrodes of one electrode pair including the common electrode and a line connecting electrodes of the other electrode pair including the common electrode may be substantially 180°.
[8] In the case [5] or case [6], an angle formed between a line connecting electrodes of one electrode pair including the common electrode and a line connecting electrodes of the other electrode pair including the common electrode may be substantially 90°.
[9] In the case [5] or case [6], an angle formed between a line connecting electrodes of one electrode pair including the common electrode and a line connecting electrodes of the other electrode pair including the common electrode may be an acute angle.
[10] In the case [5] or case [6], an angle formed between a line connecting electrodes of one electrode pair including the common electrode and a line connecting electrodes of the other electrode pair including the common electrode may be an obtuse angle.
[11] In the case [5] or case [6], the electrode structural body may include a combination of a first electrode pair and a second electrode pair sharing the common electrode where an angle formed between a line connecting electrodes of the first electrode pair including the common electrode and a line connecting electrodes of the second electrode pair including the common electrode is an acute angle and a combination of a third electrode pair and a fourth electrode pair sharing the common electrode where an angle formed between a line connecting electrodes of the third electrode pair including the common electrode and a line connecting electrodes of the fourth electrode pair including the common electrode is an obtuse angle.
[12] In the present invention, preferably, the number of positions for generating electric discharge for each of the electrodes (number of positions for generating electric discharge/number of electrodes) should be more than 0.5.
[13] In the present invention, preferably, the number of positions for generating electric discharge for each of the electrodes (number of positions for generating electric discharge/number of electrodes) should be more than 1.0.
[14] In the present invention, the plurality of electrode pairs may be provided in a flow channel of a source gas, and in at least one electrode pair among the plurality of electrode pairs, a direction from one electrode to the other electrode of the at least one electrode pair may be perpendicular to a main flow direction of the source gas.
[15] In the present invention, the plurality of electrode pairs may be provided in a flow channel of a source gas, and in at least one electrode pair among the plurality of electrode pairs, a direction from one electrode to the other electrode of the at least one electrode pair may be inclined from a main flow direction of the source gas.

In the electrode structural body according to the present invention, the number of electrodes required for a certain ozone generation rate is small, and it is possible to achieve reduction in the size and the pressure loss, and also realize cost reduction.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1A is a cross sectional view showing an electrode structural body according to a first embodiment (first electrode structural body);

FIG. 1B is a cross sectional view taken along a line IB-IB in FIG. 1A (For ease of distinction between a first electrode and a second electrode, it should be noted that only a conductor of the first electrode is hatched for showing its cross section. The same applies to the following.);

FIG. 1C is a cross sectional view showing upper three electrodes 12 (first electrode 12A (No. 1), second electrode 12B (No. 1), and first electrode 12A (No. 2)) as representative electrodes in an enlarged manner;

FIG. 2A is a cross sectional view showing a combination electrode structural body according to a reference example;

FIG. 2B is a cross sectional view showing a line IIB-IIB in FIG. 2A;

FIG. 3A is a cross sectional view showing an electrode structural body according to a second embodiment (second electrode structural body);

FIG. 3B is a cross sectional view showing upper three electrodes as representative electrodes in an enlarged manner;

FIG. 4 is a cross sectional view showing a first example of a combination electrode structural body according to a reference example;

FIG. 5 is a cross sectional view showing a second example of a combination electrode structural body according to a reference example;

FIG. 6 is a cross sectional view showing a third example of a combination electrode structural body according to a reference example;

FIG. 7A is a front view showing an electrode structural body according to an embodiment example 1 in a first experimental example and a pipe channel;

FIG. 75 is a cross sectional view taken along a line VIIB-VIIB in FIG. 7A (Note that hatching for showing the cross section of the electrode is omitted.);

FIG. 8A is a front view showing an electrode structural body according to a reference example 1 in the first experimental example;

FIG. 8B is a cross sectional view taken along a line VIIIB-VIIIB in FIG. 8A (Note that hatching for showing the cross section of the electrode is omitted.);

FIG. 9 is a graph showing a measurement result of the pressure loss in each stage in the embodiment example 1 and the reference example 1;

FIG. 10A is a graph showing a measurement result of the ozone generation rate relative to the gas flow rate of the electrode structural body according to an embodiment example 2;

FIG. 10B is a graph showing a measurement result of the ozone generation rate relative to the gas flow rate of the electrode structural body according to a reference example 2;

FIG. 11A is a cross sectional view showing an electrode structural body according to a third embodiment of the present invention (third electrode structural body);

FIG. 11B is a cross sectional view showing upper three electrodes as representative electrodes in an enlarged manner;

FIG. 12A is a cross sectional view showing an electrode structural body according to a fourth embodiment of the present invention (fourth electrode structural body);

FIG. 12B is a cross sectional view showing upper three electrodes as representative electrodes in an enlarged manner;

FIG. 13A is a cross sectional view showing an electrode structural body according to a fifth embodiment of the present invention (fifth electrode structural body);

FIG. 13B is a cross sectional view showing upper three electrodes as representative electrodes in an enlarged manner;

FIG. 14A is a cross sectional view showing an electrode structural body according to a sixth embodiment of the present invention (sixth electrode structural body);

FIG. 14B is a cross sectional view showing upper five electrodes as representative electrodes in an enlarged manner;

FIG. 15A is a cross sectional view showing an electrode structural body according to a seventh embodiment of the present invention (seventh electrode structural body); and

FIG. 15B is a cross sectional view showing upper five electrodes as representative electrodes in an enlarged manner.

### DESCRIPTION OF THE PREFERRED EMBODIMENTS

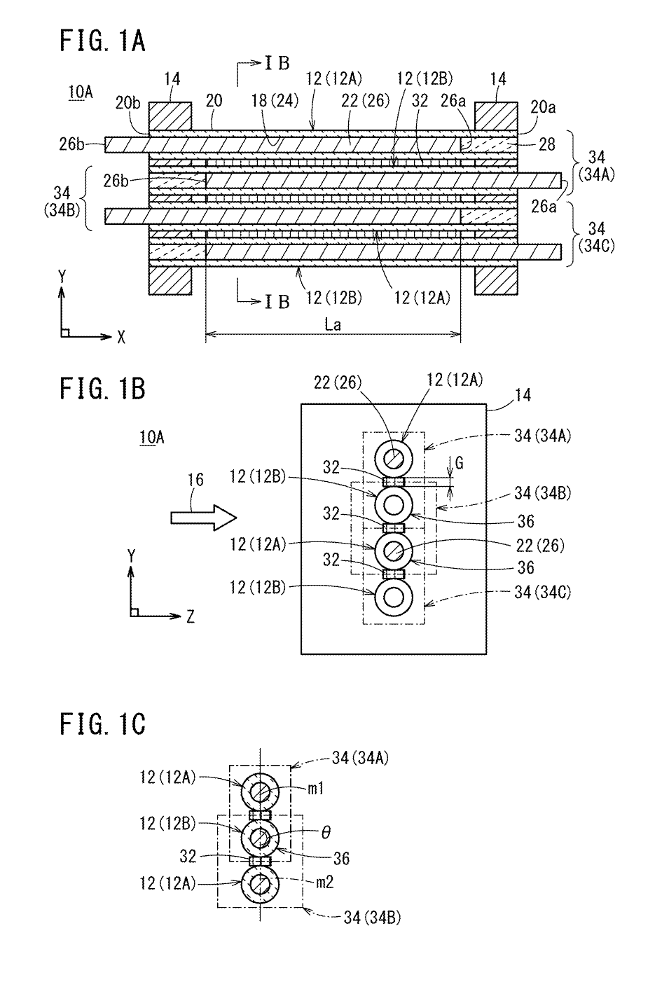

Hereinafter, embodiments of an electrode structural body according to the present invention will be described below with reference to FIGS. 1 to 15B. It should be noted that, in this description, a numeric range of “A to B” includes both the numeric values A and B respectively as the lower limit and upper limit values.

Firstly, as can be seen from FIG. 1A and FIG. 1B, an electrode structural body according to a first embodiment (hereinafter referred to as the “first electrode structural body 10A) includes four electrodes 12 (two first electrodes 12A and two second electrodes 12B) arranged in parallel using a pair of left and right fixing members 14. All of the axes of the four electrodes 12 are oriented in one direction (X direction), and are arranged in another direction (Y direction). In the case of using the first electrode structural body 10A as an electrode structural body of an ozone generator, the four electrodes 12 are arranged in the direction (Y direction) perpendicular to both of the axial direction (X direction) of the four electrodes 12 and a main flow direction (Z direction: depth direction) of a source gas 16 (see FIG. 1B). The main flow direction of the source gas 16 represents a flow direction at the central portion of the source gas 16 having directivity. This means that the source gas 16 does not have any directivity in its peripheral portion, and the flow direction of the source gas 16 in the peripheral portion without any directivity is not considered.

Each of the electrodes 12 includes a tubular insulating body 20 having a hollow portion 18, and a conductor 22 provided in the hollow portion 18 of the insulating body 20. The insulating body 20 and the conductor 22 are formed directly and integrally by firing the insulating body 20 and the conductor 22. As long as the gap between the insulating body 20 and the conductor 22 can be sufficiently small, after a green body is fired to form the insulating body 20, the conductor 22 may be inserted into the hollow portion 18 of the insulating body 20 to join the insulating body 20 and the conductor 22 integrally. The axial directions of the electrodes 12 are aligned, and the electrodes 12 are spaced from each other, using the pair of fixing members 14. Each of the insulating bodies 20 may be referred to as a dielectric body for inducing a charge.

In FIG. 1A and FIG. 1B, in each of the electrodes 12, the hollow portion 18 of the cylindrical insulating body 20 is formed as a through hole 24, and a rod of the conductor 22 (referred to as a conductor rod 26) is inserted into the through hole 24. Each of the through holes 24 of the insulating bodies 20 has a circular shape in cross section. Likewise, the conductor rod 26 has a circular shape in cross section.

The outer diameter of the insulating body 20 is in a range of 0.4 to 5 mm, and the length of the insulating body 20 in the axial direction is in a range of 5 to 100 mm. The thickness of the insulating body 20 is in a range of 0.1 to 1.5 mm. The outer diameter of the conductor rod 26 is in a range of 0.2 to 4.6 mm, and the axial length of the conductor rod 26 is in a range of 7 to 300 mm.

In the first electrode structural body 10A, one end surface 26a of each of the conductor rods 26 of the two first electrodes 12A among the four electrodes 12 is positioned inside of the through hole 24 relative to one end surface 20a of each of the insulating bodies 20. The other end surface 26b of each of the conductor rods 26 protrudes from the other end surface 20b of each of the insulating bodies 20.

Likewise, the other end surface 26b of each of the conductor rods 26 of the two second electrodes 12B is positioned inside of the through hole 24 relative to the other end surface 20b of each of the insulating bodies 20. The one end surface 26a of each of the conductor rods 26 protrudes from the one end surface 20a of each of the insulating bodies 20.

A portion of the conductor rod 26 that protrudes from the insulating body 20 is electrically connected to a power source (not shown) so as to function as an extraction electrode. The through hole 24 of the insulating body 20 contains a portion where the conductor rod 26 is not present, and such a portion may be filled with a dielectric body 28 as illustrated, or may contain the air (not shown).

The electrodes 12 are spaced from each other, and are fixed. That is, the insulating bodies 20 are spaced from each other, and are fixed. A space is present between the insulating bodies 20. Specifically, axial directions of the electrodes 12 are aligned, and the electrodes 12 are fixed such that a predetermined gap G (see FIG. 1B: e.g., 0.3 to 1.0 mm) is present between the insulating bodies 20. Consequently, electric discharge is generated at portions where the conductor rods 26 of the adjacent electrodes 12 face each other, and these portions are referred to as the positions 32 for generating electric discharge. In this case, portions where the conductor rods 26 of the first electrode 12A and the second electrode 12B face each other are the positions 32 for generating electric discharge. The positions 32 for generating electric discharge are electric discharge spaces as well. Therefore, the length La in the axial direction of a portion of the electrode 12 that is located in the position 32 for generating electric discharge is the electric discharge length.

The first electrode structural body 10A includes three electrode pairs 34 (first electrode pair 34A, second electrode pair 34B, and third electrode pair 34C). The first electrode pair 34A includes a first electrode 12A (No. 1) and a second electrode 12B (No. 1). The second electrode pair 34B includes the second electrode 12B (No. 1) and a first electrode 12A (No. 2). The third electrode pair 34C includes the first electrode 12A (No. 2) and a second electrode 12B (No. 2). Further, among the four electrodes 12 of the three electrode pairs 34, two electrodes 12 (the second electrode 12B (No. 1) and the first electrode 12A (No. 2)) form common electrodes 36 (see FIG. 1B) common to the three electrode pairs 34. In this case, the second electrode 12B (No. 1) is the common electrode 36 shared by the first electrode pair 34A and the second electrode pair 34B, and the first electrode 12A (No. 2) is the common electrode 36 shared by the second electrode pair 34B and the third electrode pair 34C.

Further, taking the first electrode pair 34A and the second electrode pair 34D as an example, as shown in FIG. 1C, an angle θ formed between the line m1 connecting the electrodes 12 of the first electrode pair 34A including the common electrode 36 (second electrode 12B (No. 1)) and the line m2 connecting the electrodes 12 of the second electrode pair 34B including the common electrode 36 (second electrode 12B (No. 1) is substantially 180°. The same applies to the second electrode pair 34B and the third electrode pair 34C.

The expression “substantially 180°” here represents any angle within a range between 175° and 185°. The same applies to the following. In at least one electrode pair 34 of the first electrode pair 34A and the second electrode pair 34B, the direction from one electrode 12 to the other electrode 12 of the one electrode pair 34 may be arranged at right angle to the main flow direction of the source gas 16.

Further, if the conductor 22 (conductor rod 26) of each of the electrodes 12 of the electrode pair 34 has a circular shape in cross section, the line m1 and line m2 are line segments connecting the centers (centers of the circles) of the respective conductors 22 of the two electrodes 12 of the electrode pair 34. Further, if the conductor 22 of each of the electrodes 12 of the electrode pair 34 has a polygonal shape (triangle, quadrangle, pentagon, hexagon, etc.) in cross section, the line m1 and line m2 are line segments connecting the centers of gravity (centers of gravity of the polygons) of the respective conductors 22 of the two electrodes 12 of the electrode pair 34. Further, of the two electrodes 12 of the electrode pair 34, if the conductor 22 of one electrode 12 of the electrode pair 34 has a circular shape in cross section, and the conductor 22 of the other electrode 12 of the electrode pair 34 has a polygonal shape in cross section, the line m1 and line m2 are line segments connecting the center (center of the circle) of the conductor 22 of the one electrode 12 of the electrode pair 34 and the center of gravity (center of gravity of the polygon) of the conductor 22 of the other electrode 12 of the electrode pair 34.

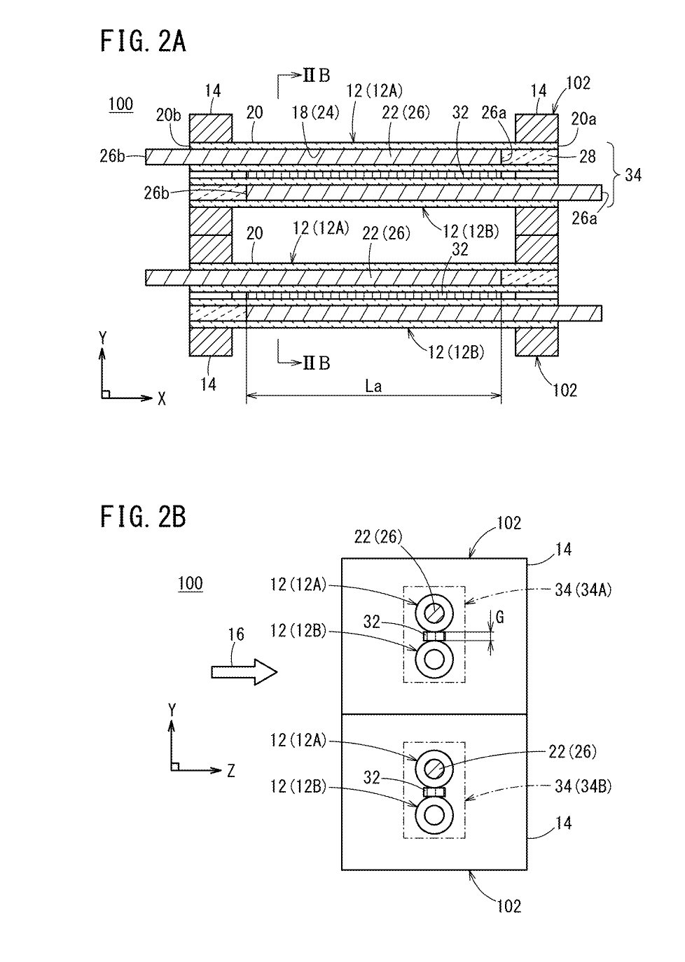

Next, the difference between an embodiment example having the same structure as the first electrode structural body 10A and a reference example shown in FIGS. 2A and 2B will be described.

As shown in FIGS. 2A and 2B, an electrode structural body according to a reference example (hereinafter referred to as the combination electrode structural body 100) is formed by combining two electrode structural bodies 102.

Each of the electrode structural bodies 102 includes two electrodes 12 (the first electrode 12A and the second electrode 12B) arranged in parallel using a pair of left and right fixing members 14. The axial directions of the electrodes 12 are aligned, and the electrodes 12 are fixed with a predetermined electric discharge gap G (see FIG. 2B: e.g., 0.3 to 1.0 mm) between the insulating bodies 20.

The combination electrode structural body 100 according to a reference example has a structure in which the two electrode structural bodies 102 are fixed by joining the fixing members 14 together to arrange the two electrode pairs 34 in parallel. Therefore, the distance between the electrode structural bodies 102 is larger than the electric discharge gap G. Consequently, no electric discharge occurs between the electrode structural bodies 102.

That is, though the combination electrode structural body 100 according to the reference example has the two electrode pairs 34, the common electrode 36 as in the case of the embodiment example is not present.

Next, the difference in the number of positions 32 for generating electric discharge and the number of electrodes 12 between the embodiment example and the reference example will be explained. As shown in the following table 1, in the embodiment example, the number of positions 32 for generating electric discharge is three, and the number of the electrodes 12 is four, and in the reference example, the number of positions 32 for generating electric discharge is two and the number of the electrodes 12 is four.

TABLE 1

| | Embodiment example | Reference example |
|---|---|---|
| Number of positions | 3 | 2 |
| for generating | | |
| electric discharge | | |
| Number of electrodes | 4 | 4 |

In a case where four electrodes 12 are used, as can be seen from the table, in the reference example, electric discharge is generated at two positions, while in the embodiment, electric discharge is generated at three positions. The ozone generation rate is substantially proportional to the number of positions 32 for generating electric discharge. Therefore, the embodiment example has 1.5 times the ozone generation rate of the reference example.

Further, as shown in the following table 2, assuming that the number of positions 32 for generating electric discharge is “n”, the number of electrodes 12 in the embodiment example is “n+1”, whereas the number of electrodes 12 in the reference example is “2n”.

TABLE 2

| | Embodiment example | Reference example |
|---|---|---|
| Number of positions | n | n |
| for generating | | |
| electric discharge | | |
| Number of electrodes | n + 1 | 2n |

Assuming that the number of positions 32 for generating electric discharge relative to the number of the electrodes 12 (=number of positions 32 for generating electric discharge/number of electrodes 12) is the utilization efficiency of the electrodes 12, the utilization efficiency in the reference example takes a fixed value of 0.5, regardless of the number of positions 32 for generating electric discharge. In contrast, in the embodiment example, the utilization efficiency is n/n+1. By increasing the number of electrodes 12, it becomes possible to make the utilization efficiency of the electrodes 12 closer to substantially 1. The utilization efficiency of the electrodes 12 can also be regarded as the generation efficiency of ozone. Therefore, by increasing the number of electrodes 12, the ozone generation rate of the embodiment example gets closer to, i.e., gradually gets closer to two times the ozone generation rate of the reference example. Stated otherwise, in the embodiment example, a smaller number of electrodes 12 are required for a given ozone generation rate.

As described above, in the first electrode structural body 10A, among the plurality of electrodes 12 forming the plurality of electrode pairs 34, at least one electrode 12 forms the common electrode 36 common to the plurality of electrode pairs 34. Therefore, the number of electrodes 12 required for a given ozone generation rate is smaller, and it is possible to achieve reduction in the size and the pressure loss, and realize cost reduction.

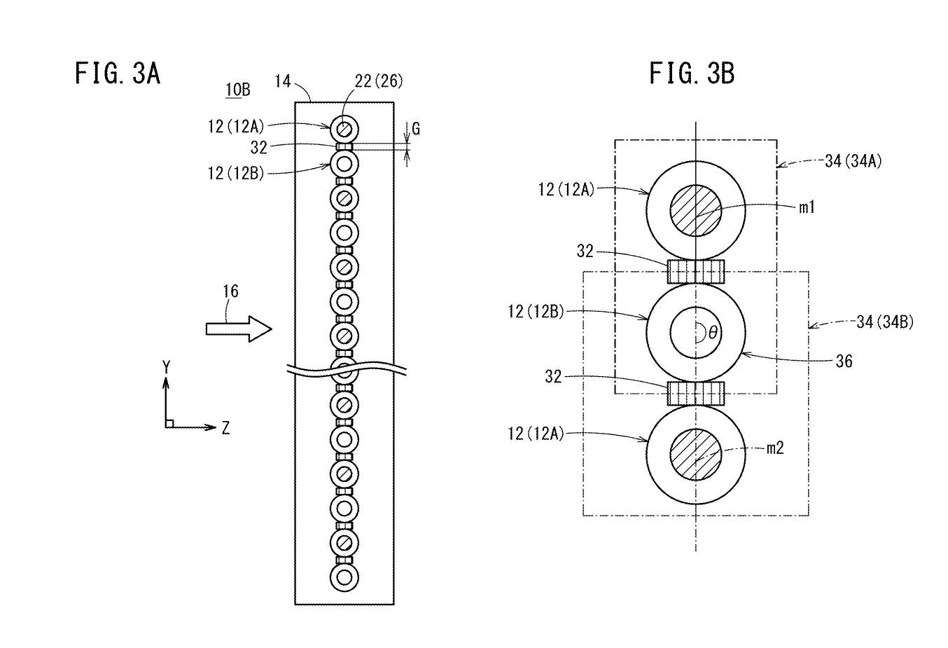

Next, an electrode structural body according to a second embodiment (hereinafter referred to as the second electrode structural body 10B) will be described with reference to FIGS. 3A and 3B.

As shown in FIG. 3A, this second electrode structural body 10B has the same structure as the above described first electrode structural body 10A. However, the second electrode structural body 10B is different from the first electrode structural body 10A in that 22 electrodes 12 are arranged in Y direction. In this case, the number of positions 32 for generating electric discharge is 21, and the utilization efficiency of the electrodes 12 is 21/22≈0.95. Further, as shown in FIG. 3B, in the case where the upper three electrodes 12 (the first electrode 12A (No. 1), the second electrode 12B (No. 1), and the first electrode 12A (No. 2)) are taken as a representative example, an angle θ formed between the line m1 connecting the electrodes 12 of the first electrode pair 34A including the common electrode 36 (second electrode 12B (No. 1)) and the line m2 connecting the electrodes 12 of the second electrode pair 34B including the common electrode 36 is substantially 180°.

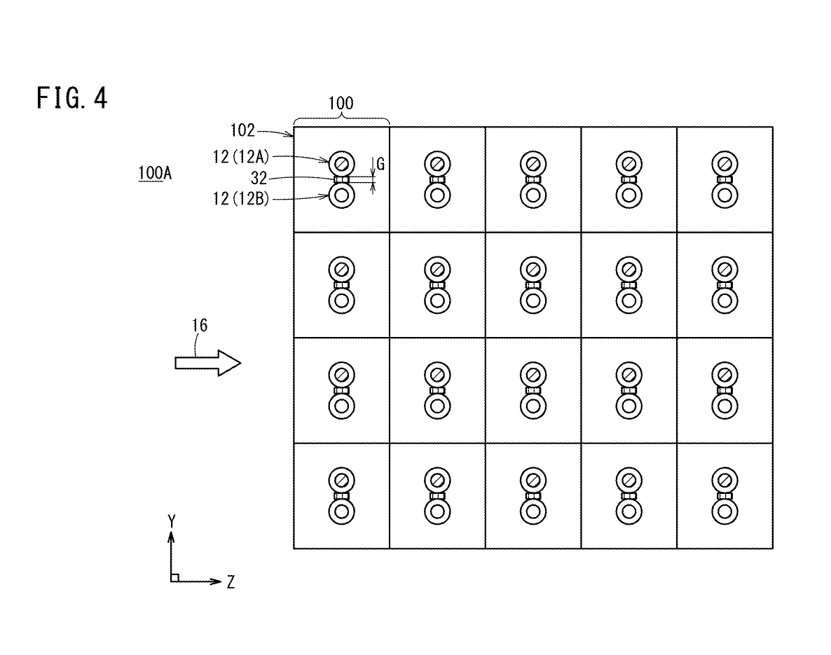

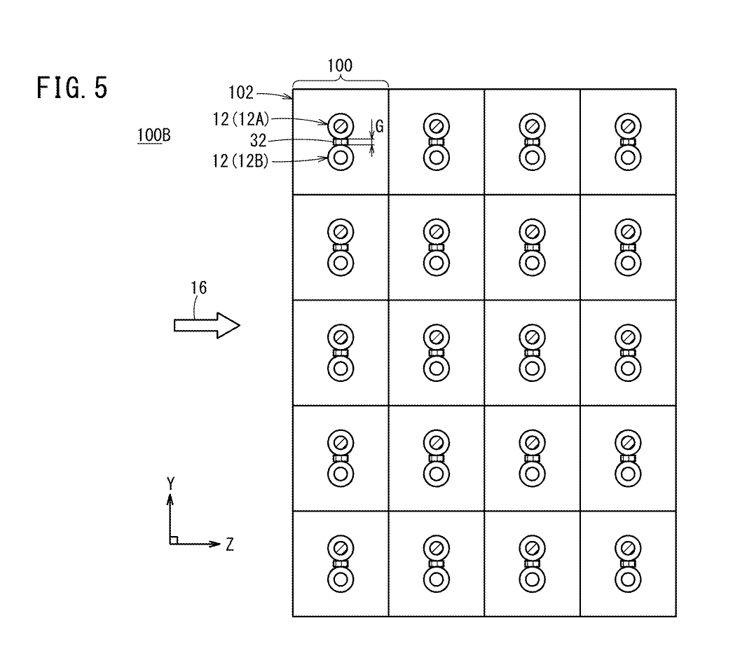

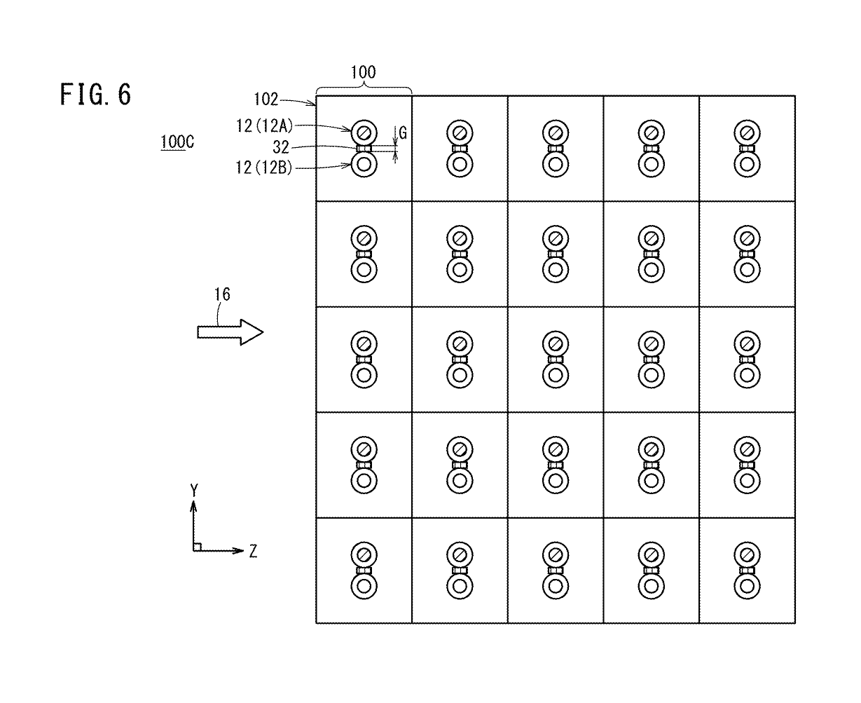

In the combination electrode structural body 100 according to the reference example, the number of positions 32 for generating electric discharge is required to be 20 to 25 in order to make the number of discharge positions 32 of the reference example closer to the number of discharge positions 32 of the second electrode structural body 10B. In this case, as shown in FIG. 4 which illustrates the combination electrode structural body 100A, four electrode structural bodies 102 each having an electrode pair 34 are arranged in the Y direction to form one combination electrode structural body 100. Then, five combination electrode structural bodies 100 of this type are arranged in a Z direction. Alternatively, as in the case of a combination electrode structural body 100B shown in FIG. 5, five electrode structural bodies 102 are arranged in the Y direction to form one combination electrode structural body 100. Then, four combination electrode structural bodies 100 of this type are arranged in the Z direction. Alternatively, as in the case of a combination electrode structural body 100C shown in FIG. 6, five electrode structural bodies 102 are arranged in the Y direction to form one combination electrode structural body 100. Further, five combination electrode structural bodies 100 of this type are arranged in the Z direction.

That is, in the structure using the reference example, it is required to combine four or five combination electrode structural bodies 100, and the structure has a large size. In contrast, in the second electrode structural body 10B, as shown in FIG. 3A, one electrode structural body having 22 electrodes 12 arranged in the Y direction is enough, and size reduction is achieved. Further, the utilization efficiency of the electrodes 12 takes a constant value of 0.5 in the combination electrode structural body 100 using the reference example. In the second electrode structural body 10E, as described above, it is possible to improve the utilization efficiency of the electrodes 12 to about 0.95, and improve the generation efficiency of ozone.

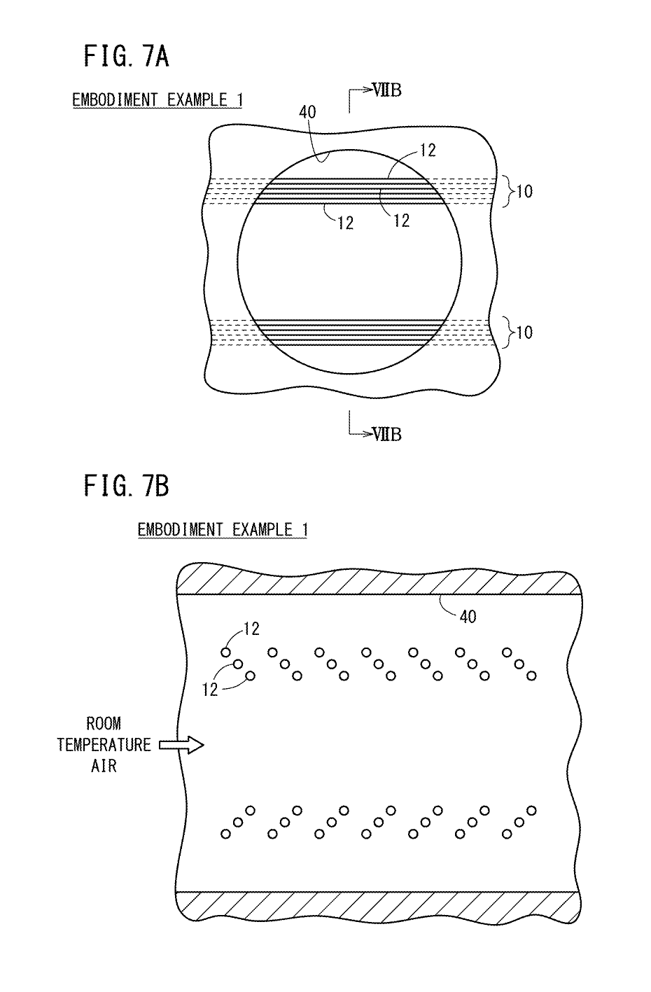

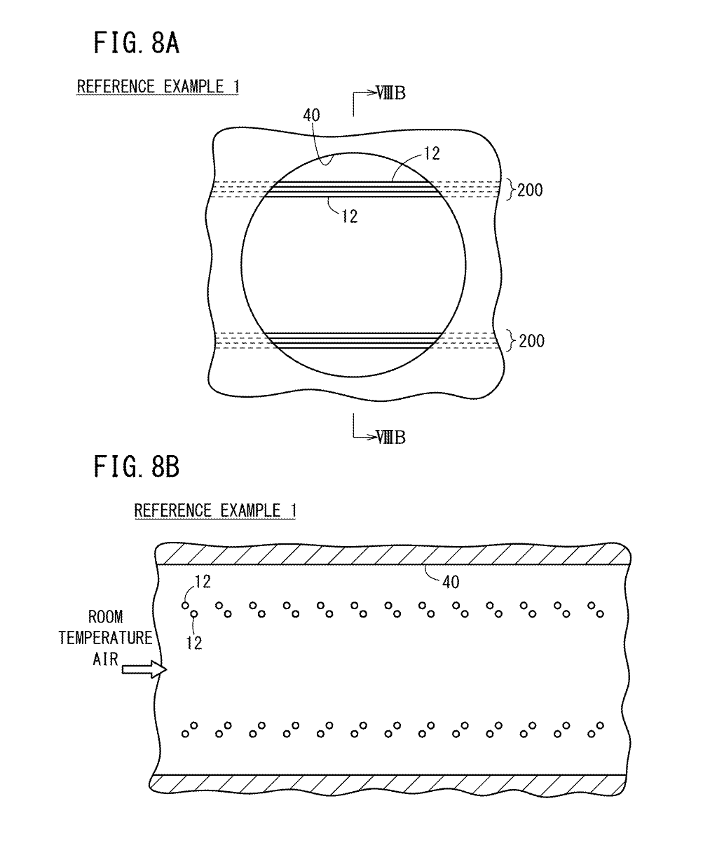

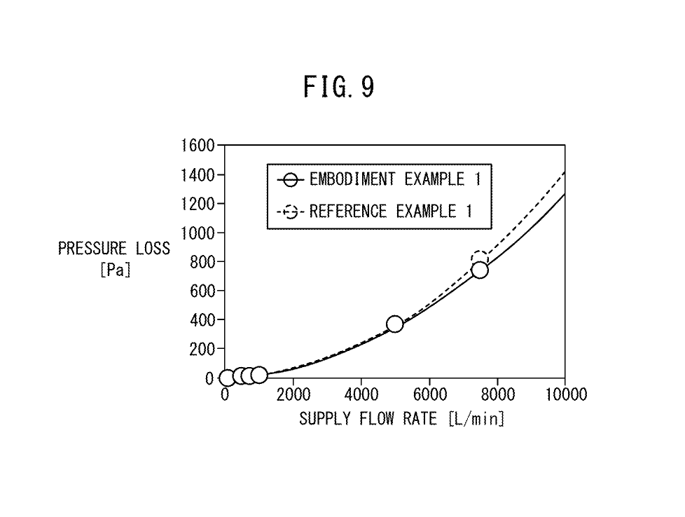

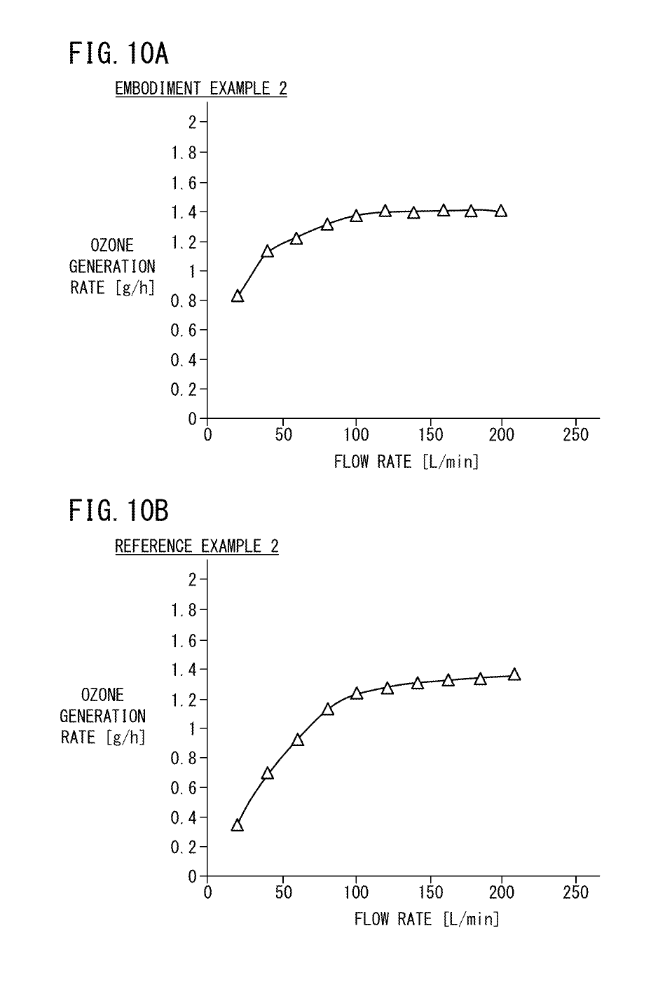

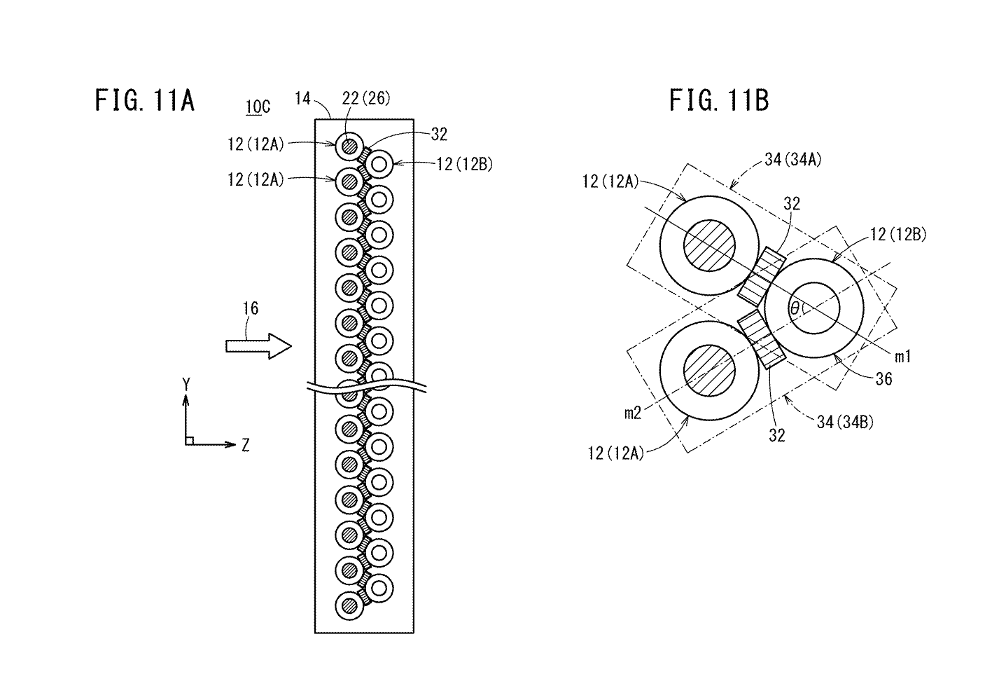

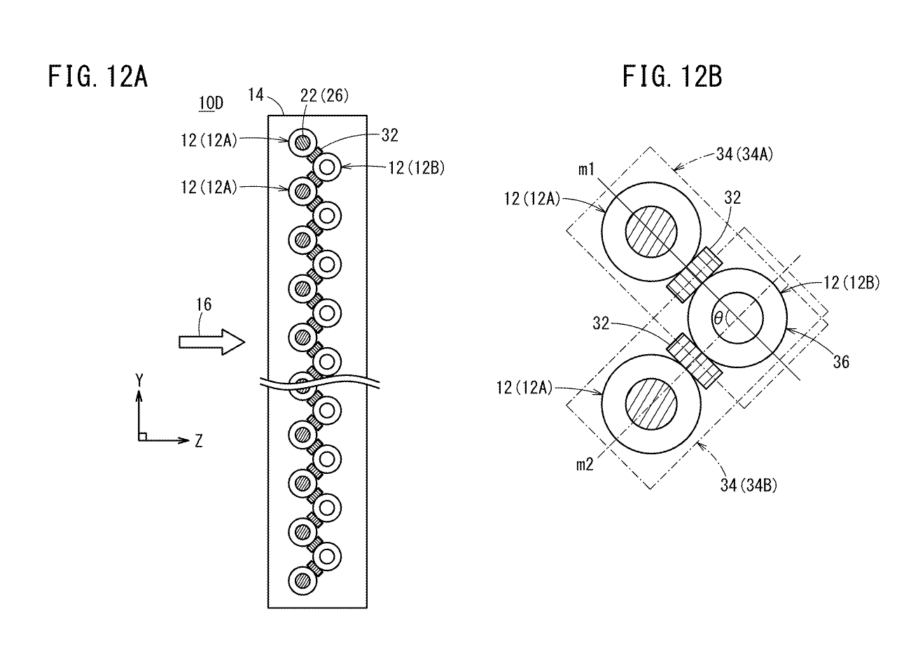

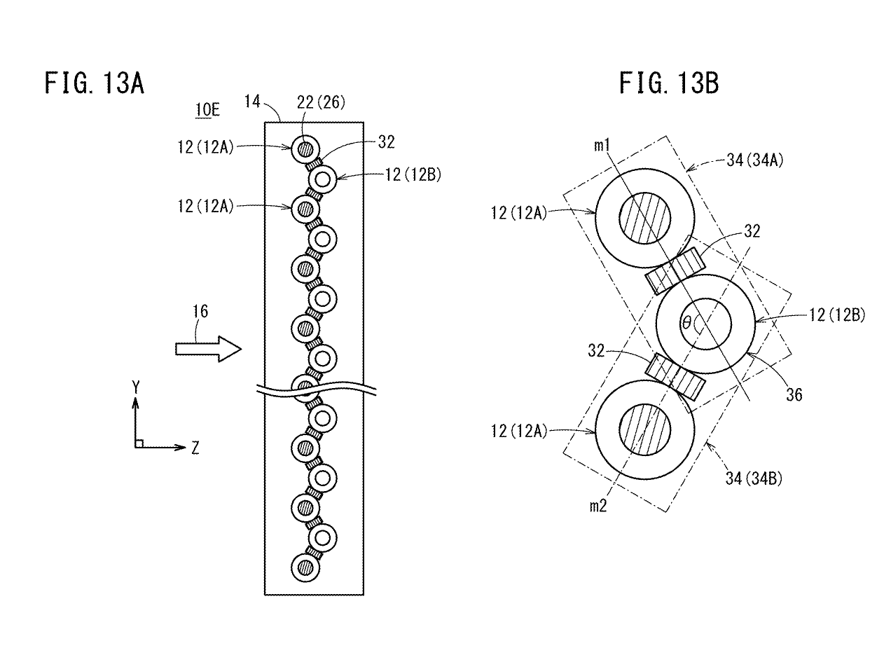

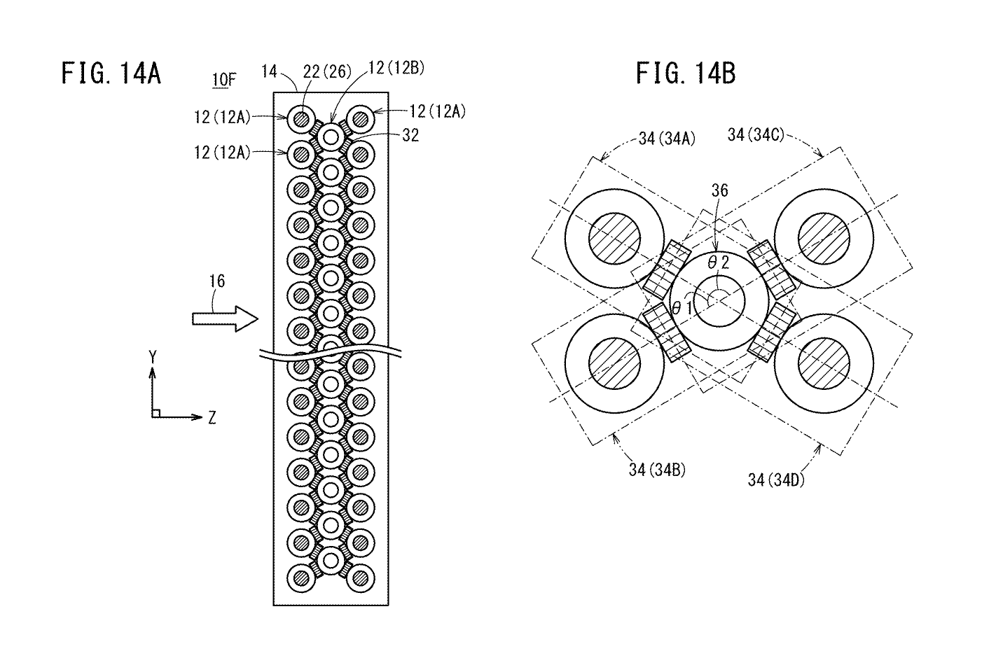

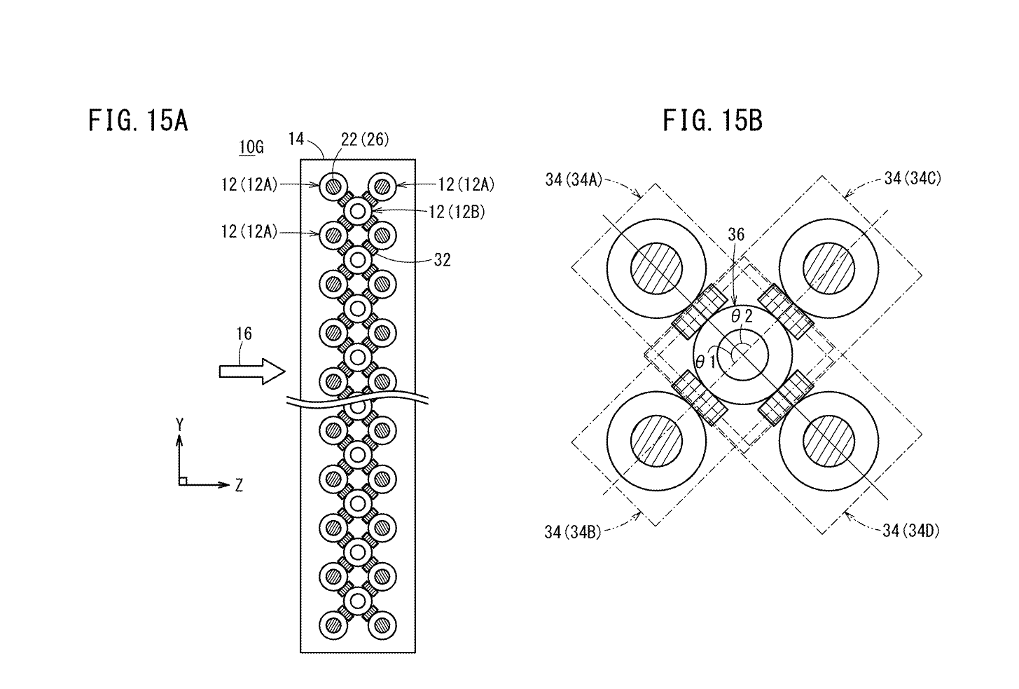

In this regard, two experimental examples (first experimental example and second experimental example) will be described with reference to FIG. 7A through FIG. 8B.

### First Experimental Example

In the first experimental example, the pressure loss was checked in each of the embodiment example 1 and the reference example 1.

### (Method of Checking the Pressure Loss)

The pressure loss was checked in the following manner. That is, as shown in FIGS. 7A to 8B, a pipe channel 40 having a circular shape in cross section (pipe channel diameter m 55 mm, pipe channel length=500 mm) was used.

In the embodiment example 1, as shown in FIGS. 7A and 7B, seven electrode structural bodies 10 each having three electrodes 12 were arranged in the depth direction of the pipe channel 40, at each of upper and lower positions of the pipe channel 40. That is, the electrode structural bodies 10 were arranged in two rows and in seven stages. The three electrodes 12 of each electrode structural body 10 were arranged such that the array direction of the electrodes 12 was inclined at 45° relative to the vertical direction, and one of the three electrodes 12 that was closer to the axis (center) of the pipe channel 40 was positioned on the deeper side. That is, in at least one electrode pair 34 (all of the electrode pairs 34 in FIG. 7B) among the plurality of electrode pairs 34, the direction from one electrode 12 to the other electrode 12 of each of these electrode pairs 34 was inclined from the main flow direction of the source gas 16. Further, the length La (see FIG. 1A) of the portions where the conductor rods 26 of the adjacent electrodes 12 faced each other, i.e., electric discharge length, is 45 mm. In this case, since the number of positions 32 for generating electric discharge was 28, the total electric discharge length was 45 mm×28=1260 mm.

In the reference example 1, as shown in FIGS. 8A and 8B, 13 electrode structural bodies 200 each including two electrodes 12 were arranged in the depth direction of the pipe channel 40, at each of upper and lower positions of the pipe channel 40. That is, the electrode structural bodies 200 were arranged in two rows and in 13 stages. The two electrodes 12 of each electrode structural body 200 were arranged such that the array direction of the electrodes 12 was inclined at 45° relative to the vertical direction, and one of the two electrodes 12 that was closer to the axis of the pipe channel 40 was positioned on the deeper side. Further, as in the case of the embodiment example 1, the electric discharge length was 45 mm. In this case, since the number of positions 32 for generating electric discharge was 26, the total electric discharge length was 1170 mm.

The pipe channel length of the pipe channel 40 is a length for measuring the pressure loss, and a distance for measuring the pressure difference. In order to develop the flow in the pipe channel 40 (i.e., in order to form the flow having a parabolic velocity distribution in the pipe channel 40), a segment having a length of 200 mm was provided on each of front-end and back-end sides of the pipe channel 40. Therefore, the total length including the pipe channel 40 and the segments on the front-end and back-end sides of the pipe channel 40 was 900 mm.

The positions of providing the plurality of electrode structural bodies 10 and 200 in the pipe channel 40 were the center in the length direction of the pipe channel 40, i.e., points spaced by 250 mm from respective pressure measurement points. Further, the gap (electric discharge gap G) between the electrodes 12 was 0.5 mm.

Then, the air at room temperature was supplied into the pipe channel 40 at different flow rates of six levels. The pressure difference between the inlet and the outlet of the pipe channel 40 in each level was regarded as the pressure loss. The details of the flow rates in six levels were 250 liters/minute (hereinafter referred to as “L/min”), 500 L/min, 750 L/min, 1000 L/min, 5000 L/min, and 7500 L/min.

### (Evaluation Result)

FIG. 9 shows the measurement result of the pressure loss in each level in the embodiment example 1 and the reference example 1. As can be seen from FIG. 9, there was no difference in the pressure loss between the embodiment example 1 and the reference example 1, until the flow rate of 5000 L/min. However, as shown in the graph, when the flow rate exceeded 5000 L/min, the difference in the pressure loss between the embodiment example 1 and the pressure loss in the reference example 1 increased with increasing flow rate. Specifically, the pressure loss in the embodiment example 1 was small in comparison with the reference example 1.

Since the number of electrodes 12 in each stage of the embodiment example 1 was large, and the total length of the electric discharge length of the embodiment example 1 was large in comparison with the reference example 1, it was expected that the pressure loss of the embodiment example 1 was larger than that of the reference example 1. However, the result was otherwise. In light of the fact that the number of the stages, i.e., 7, of the embodiment example 1 was less than the number of stages, i.e., 13, of the reference example 1, this is considered to be because the pressure loss results from the number of stages, i.e., the length in the depth direction in which the electrode structural bodies 10 and 200 are arranged, rather than the number of electrodes in each stage or the total length of the electric discharge length.

### Second Experimental Example

In a second experimental example, the difference in the ozone generation rate (ozone generation efficiency) relative to the flow rate of the source gas was checked in each of an embodiment example 2 and a reference example 2.

### (Method of Checking the Ozone Generation Efficiency)

Firstly, in order to check the ozone generation efficiency, the air was used as the source gas. The gas was supplied at flow rates of 10 levels, i.e., 20, 40, 60, 80, 100, 120, 140, 160, 180, and 200 L/min. The gas pressure was 0.25 MPa. The absolute moisture was 10 g/m³.

As a power source for electric discharge, an alternating current power source for outputting alternating voltage having the voltage (amplitude) of ±4 kV and the frequency of 20 kHz was used.

Under these conditions, the ozone concentration of the discharge gas (ozone generation rate) was measured using an ozone concentration meter EG-3000D (manufactured by Ebara Jitsugyo Co., Ltd.).

As the embodiment example 2, the second electrode structural body 10B shown in FIG. 3A was used, and as the reference example 2, the combination electrode structural body 100B according to the reference example shown in FIG. 5 was used. That is, in the embodiment example 2, the number of electrodes is 22, and in the reference example 2, the number of electrodes is 40.

### (Evaluation Results)

The measurement results of the ozone generation rate relative to the gas flow rate in the embodiment example 2 and the reference example 2 are shown in FIG. 10A, FIG. 10B, and the following table 3.

TABLE 3

| | |
|---|---|
| Flow rate | Ozone generation rate (g/h) |

| (L/min) | Embodiment example 2 | Reference example 2 |
|---|---|---|
| 20 | 0.83 | 0.35 |
| 40 | 1.13 | 0.72 |
| 60 | 1.22 | 0.94 |
| 80 | 1.31 | 1.16 |
| 100 | 1.37 | 1.27 |
| 120 | 1.40 | 1.30 |
| 140 | 1.40 | 1.34 |
| 160 | 1.41 | 1.35 |
| 180 | 1.40 | 1.37 |
| 200 | 1.40 | 1.40 |

As can be seen from the measurement results, when the gas flow rate was 200 L/min, both of the embodiment example 2 and the reference example 2 achieved 1.40 g/h. However, when the gas flow rate was less than 200 L/min, the ozone generation rate in the reference example 2 was smaller than the ozone generation rate in the embodiment example 2. In particular, the difference of the ozone generation rate between the embodiment example 2 and the reference example 2 increased with decreasing flow rate.

Therefore, the results showed that the ozone generation efficiency in the embodiment example 2 was higher than the ozone generation efficiency in the reference example 2. That is, the number of the required electrodes for a certain ozone generation rate (e.g., 1.40 g/h) was small in comparison with the reference example 2.

As can be seen from the above two experimental examples, in the second electrode structural body 10B, the number of electrodes required for a certain ozone generation rate is small, and it is possible to achieve reduction in the size and the pressure loss, and also to realize cost reduction.

Next, an electrode structural body according to a third embodiment of the present invention (hereinafter referred to as the third electrode structural body 10C) will be described with reference to FIGS. 11A and 11B.

As shown in FIG. 11A, this third electrode structural body 10C has substantially the same structure as the above described second electrode structural body 10B. However, as shown in FIG. 11B, the third electrode structural body 10C is different from the second electrode structural body 10B in that, when the upper three electrodes 12 (first electrode 12A (No. 1), the second electrode 12B (No. 1), and the first electrode 12A (No. 2)) are taken as representative electrodes, the angle θ formed between the line m1 connecting the electrodes of the first electrode pair 34A including the common electrode 36 (second electrode 12B (No. 1)) and the line m2 connecting the electrodes of the second electrode pair 34B including the common electrode 36 (second electrode 12B (No. 1)) is an acute angle. In the example of FIG. 11B, the formed angle θ is set to substantially 60°. The expression “substantially 60°” represents any angle within a range between 55° and 65°.

In this third electrode structural body 10C, 20 first electrodes 12A are arranged in the Y direction, and likewise, 19 second electrodes 12B are arranged in the Y direction. In this case, the number of the electrodes 12 is 39, and the number of positions 32 for generating electric discharge is 19×2=38. The utilization efficiency of the electrodes is 38/39≈0.97. Therefore, using the third electrode structural body 10C, it is possible to further improve the ozone generation efficiency, in comparison with the case of the above described second electrode structural body 10B.

Further, in this third electrode structural body 10C, as shown in FIG. 11B, since the positions 32 for generating electrical discharge by the first electrode pair 34A are close to the positions 32 for generating electrical discharge by the second electrode pair 34B, depending on the degree of the formed angle θ and the magnitude of the voltage applied between the first electrode 12A and the second electrode 12B, another electric discharge space is also formed between these positions 32 for generating electric discharge. Thus, it is possible to increase the volume of the electric discharge space. Accordingly, further improvement in the ozone generation efficiency is achieved.

Next, an electrode structural body according to a fourth embodiment (hereinafter referred to as the fourth electrode structural body 10D) will be described with reference to FIGS. 12A and 12B.

As shown in FIG. 12A, this fourth electrode structural body 10D have substantially the same structure as the above described third electrode structural body 10C. However, as shown in FIG. 12B, the fourth electrode structural body 10D is different from the third electrode structural body 10C in that, when the upper three electrodes (first electrode 12A (No. 1), the second electrode 12B (No. 1), and the first electrode 12A (No. 2)) are taken as representative electrodes, the angle θ formed between the line m1 connecting the electrodes of the first electrode pair 34A including the common electrode 36 (second electrode 12B (No. 1)) and the line m2 connecting the electrodes of the second electrode pair 34B including the common electrode 36 (second electrode 12B (No, 1)) is substantially 90°. The expression “substantially 90°” represents any angle within a range between 85° and 95°.

In this fourth electrode structural body 10D, 15 first electrodes 12A are arranged in the Y direction, and likewise, 14 second electrodes 12B are arranged in the Y direction. In this case, the number of the electrodes 12 is 29, and the number of positions 32 for generating electric discharge is 14×2=28. The utilization efficiency of the electrodes 12 is 28/29≈0.96. Therefore, using the fourth electrode structural body 10D, as in the case of the third electrode structural body 10C, it is possible to further improve the ozone generation efficiency, in comparison with the case of the above described second electrode structural body 10B.

Also in this case, as shown in FIG. 12B, since the positions 32 for generating electrical discharge by the first electrode pair 34A are close to the positions 32 for generating electrical discharge by the second electrode pair 34B, depending on the magnitude of the voltage applied between the first electrode 12A and the second electrode 12B, another electric discharge space is also formed between these positions 32 for generating electric discharge. Thus, it is possible to increase the volume of the electric discharge space. Accordingly, further improvement in the ozone generation efficiency is achieved.

Next, an electrode structural body according to a fifth embodiment (hereinafter referred to as the fifth electrode structural body 10E) will be described with reference to FIGS. 13A and 13B.

As shown in FIG. 13A, this fifth electrode structural body 10E has substantially the same structure as the above described third electrode structural body 10C. However, as shown in FIG. 13B, the fifth electrode structural body 10E is different from the third electrode structural body 10C in that, when the upper three electrodes (first electrode 12A (No. 1), the second electrode 12B (No. 1), and the first electrode 12A (No. 2)) are taken as representative electrodes, the angle θ formed between the line m1 connecting the electrodes of the first electrode pair 34A including the common electrode 36 (second electrode 12B (No. 1)) and the line m2 connecting the electrodes of the second electrode pair 34B including the common electrode 36 (second electrode 12B (No. 1)) is an obtuse angle. In the example of FIG. 13B, the formed angle is set to substantially 120°. The expression “substantially 120°” represents any angle within a range between 115° and 125°.

In this fifth electrode structural body 10E, 13 first electrodes 12A are arranged in the Y direction, and likewise, 12 second electrodes 12B are arranged in the Y direction. In this case, the number of the electrodes 12 is 25, and the number of positions 32 for generating electric discharge is 12×2=24. The utilization efficiency of the electrodes 12 is 24/25≈0.96. Therefore, using the fifth electrode structural body 10E, as in the case of the third electrode structural body 10C, it is possible to further improve the ozone generation efficiency, in comparison with the case of the above described second electrode structural body 10B.

Next, electrode structural body (hereinafter referred to as the sixth electrode structural body 10F) according to a sixth embodiment will be described with reference to FIGS. 14A and 14B.

As shown in FIG. 14A, this sixth electrode structural body 10F has the same structure as the above described third electrode structural body 10C. However, the sixth electrode structural body 10F differs from the third electrode structural body 10C in that two rows of the first electrodes 12A arranged in the Y direction are provided on respective both sides (one side where the source gas 16 is supplied, and the other side where the source gas 16 is discharged) of the row (central row) of the second electrodes 12B arranged in the Y direction. In this case, the electrode structural body is a multi-type electrode structural body having one type of combination of two electrode pairs 34 sharing one common electrode 36 and forming the acute angle, and another type of combination of other two electrode pairs 34 sharing the same common electrode 36 and forming the obtuse angle.

That is, as shown in FIG. 14B, the electrode structural body has two types of combinations each having two electrode pairs. That is, one type of combination contains a first electrode pair 34A and a second electrode pair 34B, which share one common electrode 36, wherein the angle θ1 formed by the first electrode pair 34A and the second electrode pair 34B is an acute angle, and the other type of combination contains the first electrode pair 34A and a third electrode pair 34C, which share the same common electrode 36, wherein the angle θ2 formed by the first electrode pair 34A and the third electrode pair 34C is an obtuse angle. It is a matter of course that the electrode structural body further has a combination of the third electrode pair 34C and a fourth electrode pair 34D sharing the common electrode 36 wherein the angle θ1 formed by the third electrode pair 34C and the fourth electrode pair 34D is an acute angle and a combination of the fourth electrode pair 34D and the second electrode pair 34B sharing the common electrode 36 wherein the angle θ2 formed by the fourth electrode pair 34D and the second electrode pair 34B is an obtuse angle. In the example of FIG. 14B, the formed angle θ1 is substantially 60°, and the formed angle θ2 is substantially 120°.

Further, in this sixth electrode structural body 10F, first electrodes 12A are arranged in Y direction in two rows each having 20 first electrodes 12A, and the two rows are arranged in the Z direction. 19 second electrodes 12B are arranged in one row between these two rows in the Y direction. In this case, the number of electrodes 12 is 20×2+19=59, and the number of positions 32 for generating electric discharge is 19×2×2=76. The utilization efficiency of the electrodes 12 is 76/59≈1.3. The utilization efficiency exceeds 100%. Therefore, in the sixth electrode structural body 10F, further improvement in the ozone generation efficiency is achieved.

Next, an electrode structural body according to a seventh embodiment of the present invention (hereinafter referred to as the seventh electrode structural body 10G) will be described with reference to FIGS. 15A and 15B.

As shown in FIG. 15A, this seventh electrode structural body 10G has the same structure as the above described sixth electrode structural body 10F. However, the seventh electrode structural body 10G is different from the sixth electrode structural body 10F in that the angle θ1 formed by two electrode pairs 34 including the common electrode 36 and the angle θ2 formed by the other two electrode pairs 34 including the common electrode 36 are substantially 90°.

That is, as shown in FIG. 15B, the seventh electrode structural body 10G have a combination of a first electrode pair 34A and a second electrode pair 34B sharing one common electrode 36 wherein the angle θ1 formed by the first electrode pair 34A and the second electrode pair 34B is substantially 90°, and a combination of the first electrode pair 34A and a third electrode pair 34C sharing the same common electrode 36 wherein the angle θ2 formed by the first electrode pair 34A and the third electrode pair 34C is substantially 90°.

Further, in this seventh electrode structural body 10G, first electrodes 12A are arranged in Y direction in two rows each having 15 first electrodes 12A, and the two rows are arranged in the direction, and 14 second electrodes 12B are arranged in one row between these two rows in the Y direction. In this case, the number of electrodes 12 is 15×2+14=44, and the number of positions 32 for generating electric discharge is 14×2×2=56. The utilization efficiency of the electrodes 12 is 56/44≈1.3. The utilization efficiency exceeds 100%. Therefore, also in the seventh electrode structural body 10G, further improvement in the ozone generation efficiency is achieved as in the case of the above described sixth electrode structural body 10F.

It is a matter of course that the electrode structural body according to the present invention is not limited to the embodiments described above, and various structures can be adopted without deviating from the gist of the present invention.

What is claimed is:

1. An electrode structural body including a plurality of electrode pairs,
wherein among a plurality of electrodes forming the plurality of electrode pairs, at least one electrode forms a common electrode common to the plurality of electrode pairs.

2. The electrode structural body according to claim 1, wherein, two electrodes forming at least one electrode pair among the plurality of electrode pairs are spaced from each other.

3. The electrode structural body according to claim 2, wherein among the two electrodes forming the at least one electrode pair, one electrode is the common electrode.

4. The electrode structural body according to claim 2, wherein the electrode includes a tubular insulating body and a conductor provided inside the insulating body; and
the insulating bodies of the two electrodes are spaced from each other, and a space is present between the insulating bodies.

5. The electrode structural body according to claim 1, wherein the plurality of electrodes forming the plurality of electrode pairs are spaced from each other.

6. The electrode structural body according to claim 5, wherein the electrode includes a tubular insulating body and a conductor provided inside the insulating body; and
the insulating bodies of the plurality of electrodes are completely spaced from each other, and a space is present between the insulating bodies.

7. The electrode structural body according to claim 5, wherein an angle formed between a line connecting electrodes of one electrode pair including the common electrode and a line connecting electrodes of another electrode pair including the common electrode is substantially 180°.

8. The electrode structural body according to claim 5, wherein an angle formed between a line connecting electrodes of one electrode pair including the common electrode and a line connecting electrodes of another electrode pair including the common electrode is substantially 90°.

9. The electrode structural body according to claim 5, wherein an angle formed between a line connecting electrodes of one electrode pair including the common electrode and a line connecting electrodes of another electrode pair including the common electrode is an acute angle.

10. The electrode structural body according to claim 5, wherein an angle formed between a line connecting electrodes of one electrode pair including the common electrode and a line connecting electrodes of another electrode pair including the common electrode is an obtuse angle.

11. The electrode structural body according to claim 5, comprising a combination of a first electrode pair and a second electrode pair sharing the common electrode where an angle formed between a line connecting electrodes of the first electrode pair including the common electrode and a line connecting electrodes of the second electrode pair including the common electrode is an acute angle and a combination of a third electrode pair and a fourth electrode pair sharing the common electrode where an angle formed between a line connecting electrodes of the third electrode pair including the common electrode and a line connecting electrodes of the fourth electrode pair including the common electrode is an obtuse angle.

12. The electrode structural body according to claim 1, wherein number of positions for generating electric discharge for each of the electrodes, i.e., number of positions for generating electric discharge/number of electrodes, is more than 0.5.

13. The electrode structural body according to claim 1, wherein number of positions for generating electric discharge for each of the electrodes, i.e., number of positions for generating electric discharge/number of electrodes, is more than 1.0.

14. The electrode structural body according to claim 1, wherein the plurality of electrode pairs are provided in a flow channel of a source gas; and
in at least one electrode pair among the plurality of electrode pairs, a direction from one electrode to another electrode of the at least one electrode pair is perpendicular to a main flow direction of the source gas.

15. The electrode structural body according to claim 1, wherein the plurality of electrode pairs are provided in a flow channel of a source gas; and
in at least one electrode pair among the plurality of electrode pairs, a direction from one electrode to another electrode of the at least one electrode pair is inclined from a main flow direction of the source gas.
